(19) United States
(12) Patent Application Publication
(10) Pub. No.: US 2013/0086063 A1
(43) Pub. Date: Apr. 4, 2013

(54) Deriving User Influences on Topics from Visual and Social Content

(71) Applicants: Trista P. Chen, San Francisco, CA (US); Gabriel A. Matus, San Francisco, CA (US)

(72) Inventors: Trista P. Chen, San Francisco, CA (US); Gabriel A. Matus, San Francisco, CA (US)

(21) Appl. No.: 13/602,086

(22) Filed: Aug. 31, 2012

Related U.S. Application Data
(60) Provisional application No. 61/529,771, filed on Aug. 31, 2011.

(51) Int. Cl. G06F 17/30

(52) U.S. Cl. CPC G06F 17/30595
USPC 707/736

(57) ABSTRACT

Analyzing digital content associated with a entity to identifier the entity's interest and influence related thereto. A set of digital content, such as text, pictures, or video, which the entity has submitted to one or more social media services, is identified. A set of interests for the entity is identified. This may be performed, in part, by analyzing a set of pictures to identify a set of visual attributes for each picture. Then, one or more descriptive labels that characterize the content shown in each picture are determined based on the set of visual attributes for each picture. Next, one or more subject categories for each picture are determined based upon the one or more descriptive labels for each picture. Thereafter, a set of actual interests for the entity is identified based, at least in part, upon the one or more subject categories associated with each digital picture.

### CLAIM OF PRIORITY

This application claims priority to U.S. provisional patent application No. 61/529,771, filed Aug. 31, 2011, entitled “Deriving User Influences On Topics From Visual And Social Content,” the contents of which are hereby incorporated by reference for all purposes as if fully set forth herein.

### BACKGROUND

The proliferation of social networking along with the ubiquitous availability of easily-portable cameras, such as in cellphones, has resulted in individuals sharing massive numbers of images and videos with other people. In addition to sharing photos and videos, people share their opinion on, and interest in, various topics, which may include commenting on or otherwise interacting with the content shared by other people. With such an overwhelming amount of shared content and social interaction between people who consume the shared content, it becomes difficult to ascertain people's main interests and how authoritative they are on certain topics, which could be useful in a number of different scenarios.

### BRIEF DESCRIPTION OF THE DRAWINGS

Some embodiments are illustrated by way of example and not limitation in the figures of the accompanying drawings, and in which like reference numerals refer to similar elements, and in which:

FIG. 1 is an illustration 100 of an example implementation for extracting a user's interest(s) in topics, according to an embodiment;

FIG. 2 is an illustration 200 of an example implementation for updating a user's interest(s) in topics, according to an embodiment;

FIG. 3 is an illustration 300 of an example approach utilizing nodes and directed edges for deriving user influences on topics, according to an embodiment;

FIG. 4 is an illustration 400 of an example approach utilizing nodes and directed edges for deriving user influences on topics, according to an embodiment;

FIG. 5 is an illustration 500 of an example approach utilizing nodes and directed edges for deriving user influences on topics, according to an embodiment;

FIG. 6 is a diagram 600 of an example implementation of utilizing user influence in the context of online advertising, according to an embodiment;

FIG. 7 is a block diagram that illustrates an example computer system upon which example embodiments may be implemented.

### DETAILED DESCRIPTION

Approaches for deriving user influences and visual and social data mining are presented herein. In the following description, for the purposes of explanation, numerous specific details are set forth in order to provide a thorough understanding of the embodiments described herein. It will be apparent, however, that the embodiments described herein may be practiced without these specific details. In other instances, well-known structures and devices are shown in block diagram form or discussed at a high level in order to avoid unnecessarily obscuring teachings of embodiments.

### OVERVIEW

Example approaches for deriving a user's interests based on digital content associated with the user are discussed herein. The digital content may be content that the user submits or uploads to a social media website or other services that facilitate social interaction around the content. Non-limiting illustrative examples of social media websites include Facebook, Google+, and any web site in which users may upload digital content to be shared with others. Digital content may include pictures, slides, documents, video, music, audio files, and any other type of visual, audio, or multimedia presentation.

Example embodiments allow “probable interests” for a user to be derived or calculated based on known interests for a user. For example, based on a set of known interests for a user, approaches are discussed which enable the determination of another set of interests (denoted “probable interests”) which the user is also likely to have. For example, if it is shown that user A likes topics 1, 2, and 3, then it may be determined that it is likely user A will also like topics 45 and 56, for example.

The specification further describes determining a measure of how influential a user is on a particular topic (or interest) in a digital social setting, such as a social media website, online forum, and the like. One reason why assessing a user's influence over a social media site on a particular subject is useful is because a more influential user on a particular subject is more valuable to an advertiser who markets products or services pertaining to that subject. In this way, advertisers may direct certain types of advertisements to those deemed most influential on the topic pertaining to the advertisement.

The measure of how influential a user is on a particular topic may be referred to herein as a social network user's influence. In an embodiment, this influence may be represented using two values, namely an authority score and a hub score. The authority score is a measure of how authoritative a user is on a particular subject. For example, a user that is widely recognized as a subject matter expect on a particular topic will have a high authority score for that topic. A hub score is a measure of the breadth and usefulness of content linked to or provided by the user on a particular topic. A good hub score indicates a user, while not necessarily being knowledgeable him or herself on a particular topic, is a good source of information on that topic. A user may not know how to fix a car, but may know who the best mechanics are in the area: in this case the user may have a low authority score, but a high hub score, in the subject of automotive repair.

Example embodiments of the present approach may perform additional analysis to generate a single influence score that reflects or represents both the authority score and the hub score. In doing so, embodiments may apply different weights to the authority score and the hub score to arrive at the combined single influence score. Alternatively, certain embodiments may perform further analysis on the authority score and the hub score to further derive additional scores or measures of a user's influence. Such additional analysis may reflect a variety of different factors, such as the basis for the user's knowledge and the length of time the user has been active in a particular social media community or communities.

Embodiments may be used to serve directed advertisements to users. For example, embodiments may be coupled to an “ad server,” which as used herein is a functional entity in an ad network responsible for delivering advertisements to users. Embodiments may be used in conjunction with an ad server to direct advertisements associated with a particular topic to those deemed most influential on that topic.

### Discovering Topic of Interest by Visual Context

Example embodiments of the present approach may be utilized to ascertain user interests in various topics. This may be accomplished by evaluating, via various approaches, certain content shared by a user on various social networks. This content may include digital content such as photos, videos, audio recordings and the like that are created by the user, and may also include content created by others, such as videos posted on public websites such as YouTube.

Thanks to the inclusion of high-quality cameras into cellphones, users can easily take numerous pictures and videos in their daily lives. While users may take photos and videos of special or out-of-the-ordinary moments, they may also take pictures of things that interest them, at the moment or otherwise. They may take pictures of meals, of prospective purchases, or at various events. Users may then “share” these photos and videos using various services and websites. They may post pictures on social media sites like Facebook or Google+, they may post a link to a video in a “tweet” on Twitter, they may upload the picture via a mobile application such as Instagram or to a service such as Flickr. Some mobile applications and websites offer locality-based networks between people, for example allowing users to see photos posted by people in their vicinity. People may also post, link to, or otherwise interact with visual content that they did not create; for example, a user may post, comment on, and/or “like” a video from YouTube that is shared on Facebook. A “like” is a positive rating used by Facebook, but for purposes of this specification, a “like” may denote any type of positive rating or interaction. A user may also rate content on a scale, for example by giving 4 “stars” out of a possible 5.

By analyzing the photos or videos a user posts, shares or otherwise interacts with, his interests on various topics can be extracted. For example, if he shares a lot of photos or video links about jogging, he is most likely interested in fitness or outdoor activities. In another example, a user might specify “gardening” as a personal interest in her Facebook profile; however, she shares a lot of photos of her playing online games. Her real interest may actually be ascertained as online games rather than gardening. Therefore, example embodiments operate to examine visual content, such as photos and videos, that a user shares to social networks to extract such user's interests in topics. The term “shared” may be construed as any interaction a user has with a piece of content; for example, the user may upload a photo, comment on a photo, perform an action such as “liking” a photo, and so on. It is understood for the purposes of this specification that any of these interactions may be construed as “sharing” the photo.

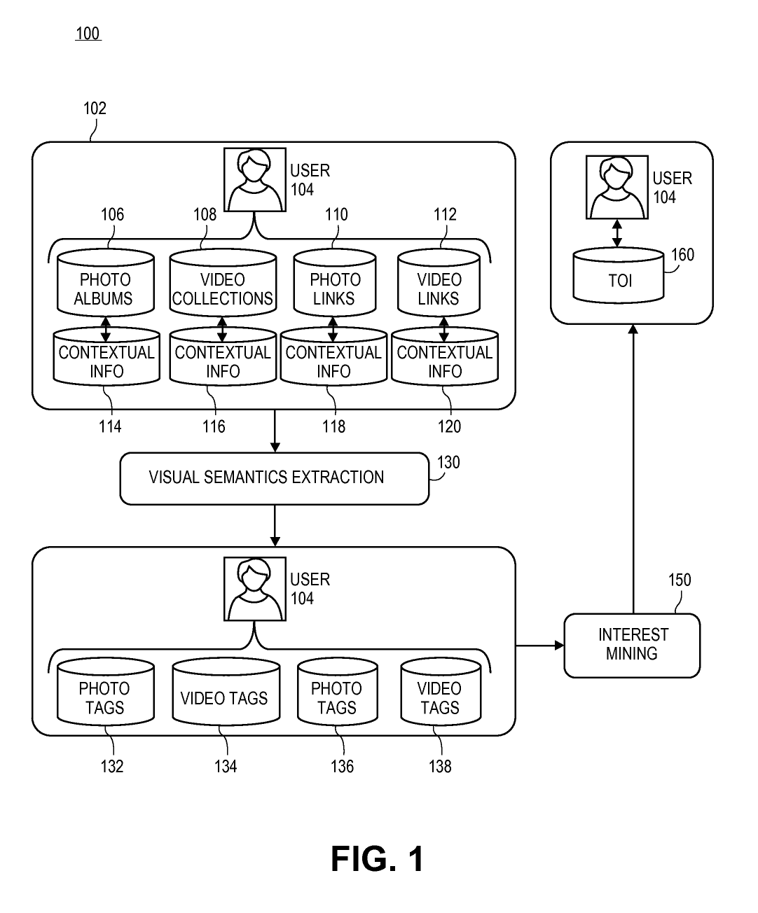

FIG. 1 is an illustration 100 of an example implementation for extracting a user's interest(s) in topics. Given a social network 102 such as Facebook or Google+, a user 104 may have numerous pieces of information associated with their account. For example, user 104 may have photo albums 106 and video collections 108 that were created and shared by user 104, or may have photo links 110 and video links 112 to content created by others (or perhaps by user 104, simply at a different service or website) and shared by user 104 on social network 102.

Each of photo albums 106, video collections 108, photo links 110 and video links 112 has associated contextual information 114-120. In an example embodiment, this contextual information 114-120 may include data such as image metadata, comments associated with the photo, video or link, the number of “likes” or other types of ratings.

Once a collection of photos and videos 106-112 associated with user 104 have been identified, the collection, along with the associated contextual information 114-120 is sent to the visual semantics extraction module 130, which in an example identifies subject matter depicted in a photo or video. An embodiment of visual semantics extraction module 130 uses a classifier to determine whether a picture (or video) possesses a certain attribute or contains a certain object. Example approaches also determine the likelihood of a picture or video containing a certain object; for example, a picture has an 83% chance of having a body of water inside. In an embodiment, visual semantics extraction module 130 returns tags 132-138 for the collection of photos/videos, 106-112 as well as tag metadata with respect to each tag 132-138. An example of tag metadata is the confidence of the tag.

An example embodiment of visual semantics extraction module 130 is a support vector machine (SVM). A SVM is a software component design to analyze a digital picture to determine whether the picture depicts a certain object or possesses a certain attribute. As an illustration, a SVM may be used to determine whether a digital picture depicts an indoor image or outdoor image or whether a digital picture depicts a mountain range, a body of water, a kitchen, a face, etc. A SVM, after analyzing a digital picture, may generate one or more tags associated with the subject matter depicted in the digital picture, e.g., a digital picture depicting an outdoor scene may be associated with the tag “outdoor” and “lake.” Any number of SVMs may be employed by embodiments and so a large amount of data may be generated that characterizes the displayed contents of a digital picture. In an embodiment, a SVM outputs the classification result as classes. The tags of the photo or video are the class labels.

Another example embodiment of visual semantics extraction module 130 is the nearest neighbor (NN) method, wherein a digital picture depicting unknown content is compared to other digital pictures depicting known content to determine which known images are most similar to the picture depicting unknown content. For example, the hash value of a photo is compared with other hash values in the database. The tags associated with the photo that has the nearest hash value to the hash value of the query photo are then transferred to the query photo.

Example embodiments may employ any technique or approach for analyzing digital content to determine its content. Video may be analyzed by examining individual frames of the video. Alternately or additionally, the motion flow of the video may be analyzed by evaluating two or more images together to determine how bounded regions of color move over time in the video. Such motion flow may be helpful in determining what is depicted in the digital video. Other approaches to determining video content include average shot length, variation in shot length, video tempo, or approaches utilizing the time-axis concept.

In an embodiment, visual semantic analysis may be performed to determine how to assign categories to depicted subject matter in digital content. For example, if a set of one or more digital pictures depicts beer and/or a group of people sitting on a couch, the overall interest or topic depicted or represented by these one or more digital pictures may be determined to be football, rather than beer or couch-sitting. Analysis of this nature allows the topics/interests assigned to digital images to be at an appropriate level of granularity and/or interest/relevance to advertisers.

In certain embodiments, additional data associated with the user may be analyzed in addition to the digital content that the user uploads. For example, the text on the user's Facebook wall may be evaluated using a certain weight when determining the user's interests.

Tags and tag metadata 132-138 are then passed to an interest mining module 150, which in an embodiment extracts the user topics of interests (TOI) 160. The TOI 160 with respect to each user may be stored, for example in the system database for later use. In an embodiment, interest mining module 150 reduces the visual content analysis result, i.e. the tags, to semantics. In one embodiment, interest mining module 150 is implemented as a tracer of a directed acyclic graph (DAG), wherein given two concepts, can one be a subset of the other by tracing the DAG tree. Given a tag, the tracer determines if such a tag is a child node of another node. If so, the derived semantics is the tag represented by this another node. For example, tags “apple” and “orange” are mapped to the concept “fruit”. In another embodiment, interest mining module 150 is implemented as a Bayes network in a probabilistic concept tree. For example, tags “skiing” and “hiking” with high confidences are mapped to the concept “outdoor activities”.

An example embodiment of interest mining module 150 counts the frequency of occurrences of each tag and selects the “top-K” most frequent tags as the user's TOI 160, where K could be 1, 2, 5, or any positive integer number. For example, the interest mining module selects the top-10 most frequent tags as the TOI. Another example of interest mining module 150 maps the extracted tag and its confidence to a concept category. Interest mining module 150 then counts the frequency of occurrences of each concept and selects the top-K most frequent concepts as the user's TOI 160. For example, tags such as “skiing” and “hiking” that have high confidences are mapped to the concept “outdoor activities”. Interest mining module 150 outputs “outdoor activities” as the user's TOI 160.

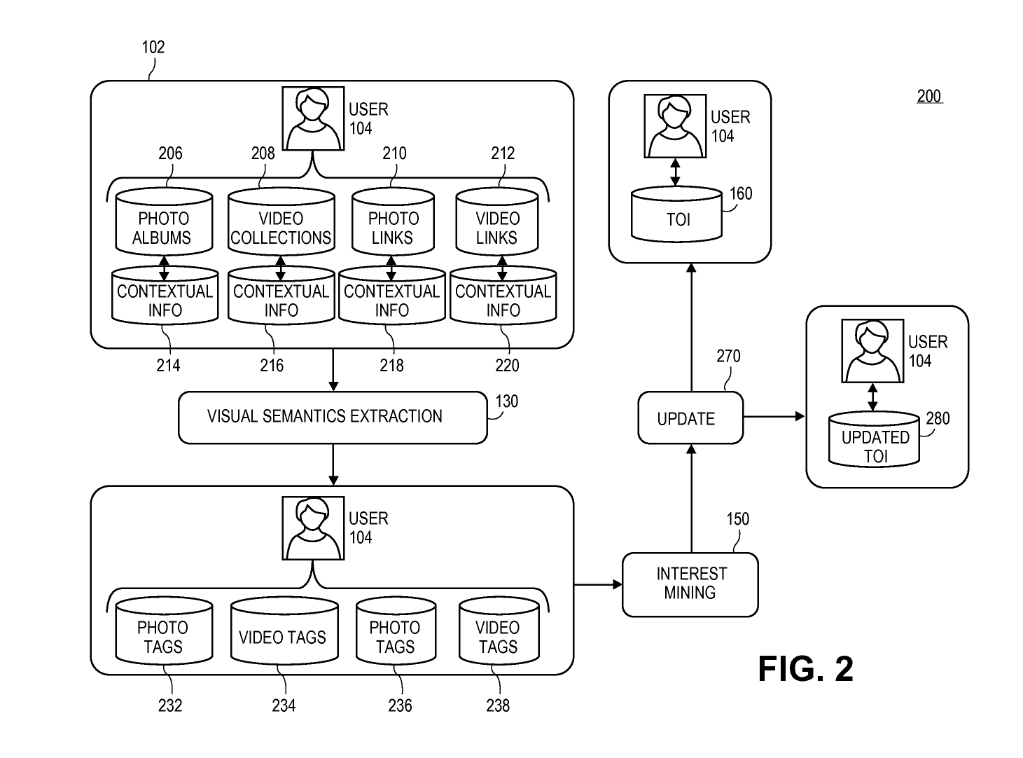

In an embodiment, a user's topics of interests may be updated. For example, a user may upload or link to a new set of photos and/or videos that concern a new interest. FIG. 2 is an illustration 200 of an example implementation for updating a user's interest(s) in topics. In this example, the user 104 of FIG. 1 may upload new photos 206 or videos 208, or link to new photos 210 or videos 212. These updated portions of the users collection 206-212 along with the existing collection are identified and visual semantics extraction module 130 analyzes the user's updated collection 206-212 along with the associated contextual information 214-220, as described above, and returns tags 232-238 for the collection of photos/videos, 206-212 as well as tag metadata with respect to each tag 232-238. Tags and tag metadata 232-238 for the updated collection are then passed to interest mining module 150, which in an embodiment extracts an incremental TOI for the user. An update module 270 combines the incremental TOI with the current TOI 160 to calculate an updated TOI 280.

An example technique for combining the incremental TOI with the current TOI 160 to calculate an updated TOI 280 is:

(updated TOI)=(1−α)·(current TOI)+α·(incremental TOI) (EQUATION 1)

According to an example, updated TOI is the new TOI desired to be calculated. It has a term from the current time instant, time m, without memory/history, and a term from the history till time (m−1). Incremental TOI is the term from current time. It is the interest coming out of the “interest mining” engine at the current time instant, time m. It does not consider anything in the past. Current TOI is a history term, the current state of TOI.

The value of a may, in one example, be between 0 and 1. As an example, a value of 0.15 for a means an updated TOI 280 will have less than half the contribution from the TOI from five iterations ago. This example update technique focuses more on a user's recent shares. A user might share a lot of skiing photos a few months back in winter while his recent shares are biking photos taken in summer. His TOI hence focuses more on the interest of biking rather than skiing. Different topics may utilize a different decay factor α; for example, some interests last longer than others.

According to an embodiment, approaches for extracting a user's interest in topics is comprised of various modules programmed to perform various tasks. These modules may be implemented in hardware or software and may comprise internal connections (not shown in FIG. 1) allowing the various modules to be communicatively coupled in any desired configuration, as well as allowing one or more modules to be communicatively coupled to external devices. Additional modules not explicitly shown in FIG. 1 may also be included in other implementations, and modules and/or their functionality may be combined or divided into further modules in certain embodiments.

### Deriving User Influences on Topics

Example embodiments determine a measure of how influential a user is on a particular topic (or interest) in a social network or digital social setting, such as a social media website, online forum, and the like. The term “social network” includes a social structure made up of entities called nodes. For example, the entity can be a person, an organization, a “page” (e.g., in Facebook.com terminology), and/or a “place/landmark” (also a type of page but more location related, for example, Golden Gate Bridge).

In an example embodiment, Nodes are connected either by “interrelationships” or “spontaneous interactions”. “Interrelationships” refer to friendship, common membership, etc. “Spontaneous interactions” refer to actions, for example social website actions such as commenting, liking, disliking, rating, re-sharing, checking-in (in the case of interacting with a place), etc. Social network may mean not only the more static social networks a user joins, e.g. Facebook, Twitter, MySpace Google Plus, PlayStation Network, etc., but also the more ad-hoc relationships a user establishes on the fly, e.g. a proximity-based user network established by an mobile app with locality information.

In an example, a node i represents a person, group, or organization in a social network. A directed edge e₁_{_{→}}ⱼ from node i to node j exists if:
a) node i follows node j;
b) node i makes a comment on something node j shares;
c) node i “likes” (in Facebook terminology, as described above) or “+1's” (in Google+ terminology) on something node i shares; or
d) node i rates something node j shares.

According to an example, the above conditions (a)-(d) for directed edge e₁_{_{→}}ⱼ is not an exhaustive list, but is merely exemplary.

In an example embodiment, the weight given to all directed edges e₁_{_{→}}ⱼ is one; i.e., the corresponding entry in the adjacency matrix is one, as described herein. Links may be assigned different weights in certain embodiments. For example, a “like” action on Facebook may be assigned a lesser weight than a comment on something node j shares, a rating, or a follow action (e.g., on Twitter). In another example, in a rating system of one to five stars, the edge can be given a weight value of one to five depending on how node i rates what node j shares. Alternately or additionally, the weights of two or more links may be summed in an embodiment. For example, if a user “likes” a post on Facebook and also provides a comment, this may be assigned a greater weight than either action individually.

Example embodiments may handle negative comments, such as a “dislike” in Facebook, using a different model than how “positive” comments and actions are treated. Expressing that one does not like a certain merchant is still useful information to someone evaluating merchants from which to purchase goods. Thus, while the comment may be negative, it is useful information and should not be automatically interpreted as having a negative value, as discussed herein.

An example approach to determining a user's influence on a topic may comprise assembling a collection Γ of individuals, which contains hubs and authorities, given a topic τ. Hubs or hub nodes are those nodes that point to authorities. Authorities or authority nodes are those with hubs pointing to them. That is, the collection Γ does not contain lonely nodes that point to no one or no one points to. The link structure induced by such a collection Γ allows the computation of “authority scores” and “hub scores” of this topic τ for each individual in the collection Γ. Authority score means how authoritative a node represents. Hub score means how connected a node represents. An example approach to assembling collection Γ is:
a) Given a topic τ, a term-based search query-string σ is established. The root set R_{σ} is obtained by performing a term-based search with the query string σ.
b) From R_{σ}, a base set Γ is derived which consists of individuals in the root set R_{σ}, individuals that point to an individual in R_{σ}, and individuals that are pointed to by an individual in R_{σ}.

The term-based search query-string σ, in an embodiment, is not the same as the topic τ. As an example, given the topic “beer,” we can use the search query-string “football” since people may often be drinking beer while watching football games. The choice of the search query-string is based on factors such as the query-string's relevance, granularity, etc., to the topic.

Another example approach to assembling collection Γ is:
a) Given a topic τ, a content-based search query-instance σ is established. The root set R_{σ} is obtained by performing a content-based search with the query instance σ. As an example, such query instance σ may be a set of example photos/videos related to the topic τ, or a set of model parameters (e.g., dominant color, eigenvalues of a picture are model parameters describing a picture) describing the topic τ.
b) From R_{σ}, a base set Γ is derived which consists of individuals in the root set R_{σ}, individuals that point to an individual in R_{σ}, and individuals that are pointed to by an individual in R_{σ}.

Similarly to the previous example approach, the term-based search query-instance σ does not need to be the same as the topic τ. For example, given the topic “beer”, we can use the search query-instance comprising a set of images with a “football” scene. The choice of the search query-instance is based on factors such as the query-string's relevance, granularity, etc., to the topic.

In an embodiment, the collection Γ and its link structure can be seen as a directed graph. The nodes of the directed graph are the individuals in the collection Γ. For all i,jεΓ, the directed edge e₁_{_{→}}ⱼ exists in Γ if and only if individual i points to individual j. Example conditions that individual i points to individual j were described earlier (items (a)-(d) after paragraph 56). An example then uses an adjacency matrix L to describe such a graph, that is, l_{1,j}=1 if individual i points to individual j and l_{1,j}=0 otherwise. Again, as described above, l_{1,j} does not need to be binary 0 or 1, but can be real-value numbers.

An example embodiment calculates authority scores of all individuals, i.e., the authority vector x and the hub scores of all individuals, i.e., the hub vector y. In an example, a guiding principle is that good authorities are individuals that are pointed to by good hubs, and good hubs and individuals that point to good authorities.

This concept may be mathematically expressed by the following, where the transpose of the adjacency matrix L may be denoted as L^{T}.

x^{(k)}=L^{τ}y^{(k-1)}

y^{(k)}=Lx^{(k)} (EQUATION 2)

where k≧1 and y⁽⁰⁾=[1 1 . . . 1]^{T}

This equation may be rewritten as:

x^{(k)}=L^{T}Lx^{(k-1)}=Ax^{(k-1)}

y^{(k)}=LL^{T}y^{(k-1)}=Hy^{(k-1)} (EQUATION 3)

where A=L^{T}L is the authority matrix and H=LL^{T} is the hub matrix.

To solve for the authority vector x and hub vector y, example embodiments use one of three methods, although other methods are envisioned: 1) iterative method; 2) eigen-analysis; or 3) singular value decomposition (SVD). In an example, the iterative method starts from letting x⁽⁰⁾=[1 1 . . . 1]^{T}. It repeatedly computes x^{(k)}=Ax^{(k-1)} and normalizes x^{(k)}=x^{(k)}/m(x^{(k)}) where m(x^{(k)}) is the signed component of the maximal magnitude. The process continues until x^{(k)} converges to x. The hub vector y is then given by y=Lx.

In the example of eigen-analysis, the authority vector x is the eigenvector that corresponds to the largest eigenvalue of the authority matrix A. And the hub vector y is the eigenvector that corresponds to the largest eigenvalue of the hub matrix H. Alternatively, the hub vector y can be computed by y=Lx.

In the example of SVD, the authority vector x is the right singular vector associated with the highest singular value of the adjacency matrix L. And the hub vector y is the left singular vector associated with the highest singular value of the adjacency matrix L.

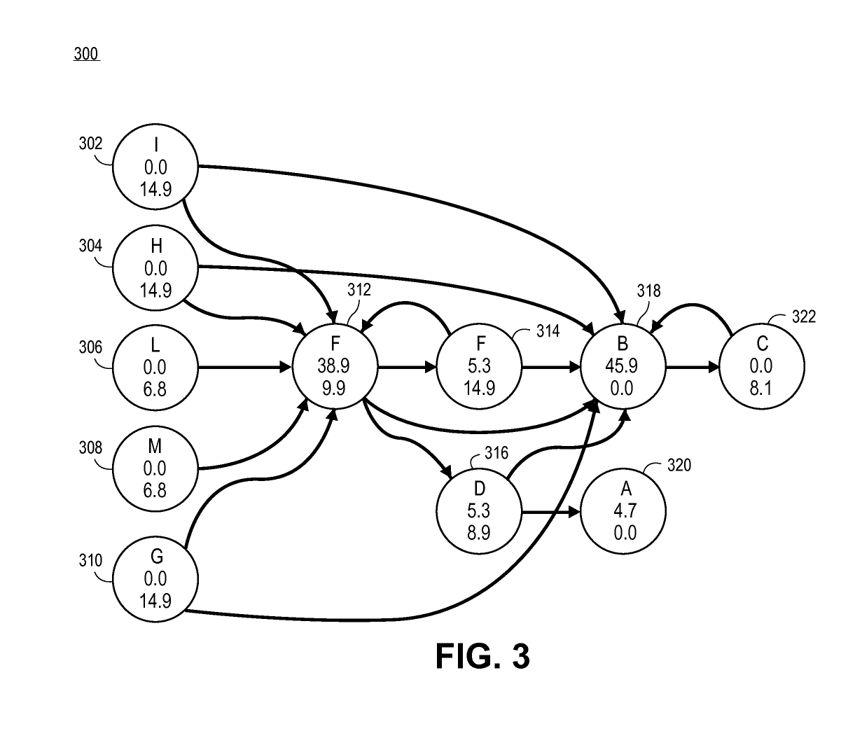

FIG. 3 is an illustration 300 of an example approach utilizing nodes and directed edges for deriving user influences on topics. In FIG. 3, each node 302-322 represents an individual. Within each node 302-322 the top letter is a node ID, the middle value is its authority score, and the bottom value is its hub score. The directed edge from one node to another represents one individual pointing to another individual. Scores have been normalized to sum to 100. Node 1302 for example has a zero authority score because no one points to it. It has a good hub score of 14.9 because it points to nodes with high authority scores. Node E 312 has a high authority scores because good hubs are pointing to it.

As an example, each node in FIG. 3 may represent a Facebook user and the topic of interest is the Golden Gate Bridge (GGB). All the users in FIG. 3 show various degrees of interest in the GGB. Some may post pictures of GGB, while others “share” pictures of GGB that were originally posted by others. In this example, User E 312 posted a picture of GGB and many other users I, H, etc. shared it. Therefore, user E 312 is very authoritative in the topic of the GGB. User I 302 shares pictures from users E 312 and B who are authoritative in the topic. Therefore, even though user I 302 doesn't post original pictures, it may be determined that user I 302 knows where to go to for good content.

In an example, EQUATION 3 may be modified to obtain the uniqueness and stability of the solution thusly:

x^{(k)}=ε\vec{1}+(1−ε)Ax^{(k-1)}

y^{(k)}=ε\vec{1}+(1−ε)LHy^{(k-1)} (EQUATION 4)

where ε=[1 1 . . . 1]^{T}.

As discussed above, “dislikes” or negative ratings need to be treated specially. A dislike implemented as an edge with weight of negative one, or a negative rating implemented as an edge with weight of negative value, should be carefully treated. In one embodiment, a separate adjacency matrix \hat{L} is constructed with links about “dislikes”. The mis-authority and mis-hop scores of each node are computed from \hat{L}. With regard to mis-authority and mis-hop scores: in the negative universe, the weight assigned to the edge with respect to a “dislike” is still 1; that is, with respect to a negative comment the weight is still a positive number, and example approaches still compute the same way. The resulting scores of a node means how bad (mis-authority and mis-hop) this node is (e.g. links to another nodes that tell wrong information) is. The adjacency matrix L is constructed as previously described with links about “likes”.

Example approaches derive a single “importance score” (or “influence score”) by evaluating the nodes and directed edges. In one approach, let C={c_{1,j}} be a square matrix of size equal to the number n of nodes (individuals). The entry c_{1,j}=1/q₁ exists if the directed edge e₁_{_{→}}ⱼ exists; otherwise, c_{1,j}=0. The value q₁ denoted the number of distinct outgoing links of node/individual i. The rank πⱼ of node j is recursively defined as:

$${π}_{j} = {\sum }_{i} {π}_{j} {c}_{i , j} \qquad ( EQUATION 5 )$$

The rank vector π is the solution of:

π=πC (EQUATION 6)

Example approaches use iterative method or eigen-analysis to solve Equation 6. The example iterative approach starts from letting π⁽⁰⁾=[¹/n ¹/n . . . ¹/n]^{T}. It repeatedly computes π^{(k)}=π^{(k-1)}C until ∥^{π(k)}−π^{(k-1)}∥<ε, where ∥•∥ is the distance measure and ε is the desired precision. The rank vector it is the eigenvector that corresponds to the largest eigenvalue of the matrix C. In addition to the above techniques, a single influence score may be determined by combining the authority score and hub score, in one example via linear combination.

Inferring Topic Influence from Related Topics

In some cases, a particular topic may be obscure or rare, such that it may be difficult to find a meaningful base set Γ with a connected graph, as described above. Example embodiments offer techniques to infer a particular individual's influence on a topic by evaluating the individual's influence on related topics. In one example, an approach utilizes visual semantic taxonomy structures to cope with the sparse nature of the adjacency matrix, given a particular topic. Topics may be “related” to other topics in various ways. A topic may be correlated to another topic or unrelated, it may be a subset of or a superset of, and so forth.

In an embodiment, user influences on a topic τ can be derived from a summation of two adjacency matrixes of two related topics τ₁ and τ₂, respectively, if the two topics are equally related to the topic τ. In this example,

L=Lₜ_{₁}+Lₜ_{₂} (EQUATION 7)

The authority matrix may then be expressed as:

$$\begin{matrix}A = {L}^{T} L \\ = {( {L}_{{t}_{1}} + {L}_{{t}_{2}} )}^{T} ( {L}_{{t}_{1}} + {L}_{{t}_{2}} ) \\ = {L}_{{t}_{1}}^{T} {L}_{{t}_{1}} + {L}_{{t}_{1}}^{T} {L}_{{t}_{2}} + {L}_{{t}_{2}}^{T} {L}_{{t}_{1}} + {L}_{{t}_{2}}^{T} {L}_{{t}_{2}}\end{matrix} \qquad ( EQUATION 8 )$$

Equation 8 composes authority matrix of topic τ₁, authority matrix of topic τ₂, and two cross terms. If the two topics are unrelated, there will be very few cross-links; hence, the contribution of the cross terms will be low. The hub matrix may be expressed as:

$$\begin{matrix}H = {LL}^{T} \\ = ( {L}_{{t}_{1}} + {L}_{{t}_{2}} ) {( {L}_{{t}_{1}} + {L}_{{t}_{2}} )}^{T} \\ = {L}_{{t}_{1}} {L}_{{t}_{1}}^{T} + {L}_{{t}_{1}} {L}_{{t}_{2}}^{T} + {L}_{{t}_{2}} {L}_{{t}_{1}}^{T} + {L}_{{t}_{2}} {L}_{{t}_{2}}^{T}\end{matrix} \qquad ( EQUATION 9 )$$

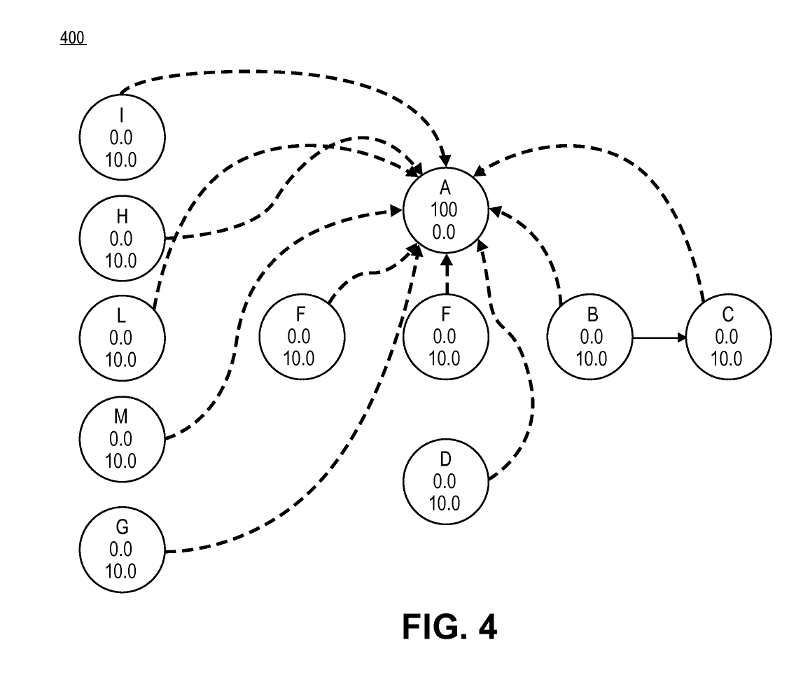

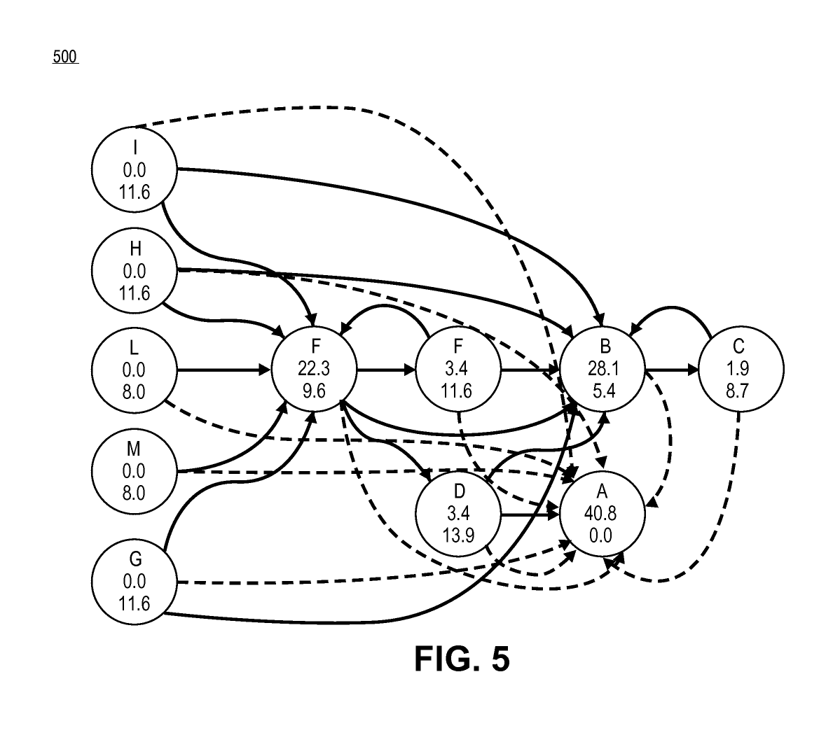

In the example of Equation 9, L τ₁ is represented by FIG. 3 and L τ₂ is represented by FIG. 4, while the resulting authority and hub scores of nodes of topic τ are shown in FIG. 5.

In another embodiment, user influences on topic τ can be derived from a weighted sum of two adjacency matrixes of two related topics τ₁ and τ₂, respectively. If one topic τ₁ is more related to the topic τ than the other topic τ₂, illustrated by the following equation:

L=uLₜ_{₁}+vLₜ_{₂}, u>ν (EQUATION 10)

Then the resulting authority matrix is:

$$\begin{matrix}A = {L}^{T} L \\ = {( {uL}_{{t}_{1}} + {vL}_{{t}_{2}} )}^{T} ( {uL}_{{t}_{1}} + {vL}_{{t}_{2}} ) \\ = {u}^{2} {L}_{{t}_{1}}^{T} {L}_{{t}_{1}} + uv ( {L}_{{t}_{1}}^{T} {L}_{{t}_{2}} + {L}_{{t}_{2}}^{T} {L}_{{t}_{1}} ) + {v}^{2} {L}_{{t}_{2}}^{T} {L}_{{t}_{2}}\end{matrix} \qquad ( EQUATION 11 )$$

It can be seen that the authority matrix of topic τ₁ dominates.

In social networks, influences of individuals that are within a user's first degree of connections usually get taken more seriously than individuals at second-degree or further. Influence scores can be computed differently depending on the number of hops nodes are away from the node in consideration. This is realized by modifying the adjacency matrix. First, we denote the adjacency matrix with the first degree of connections:

L₁=(L₁₁) (EQUATION 12)

Then we determine the adjacency matrix with the second degree of connections:

$${L}_{2} = ( \begin{matrix}{L}_{11} & {f}_{2} ( ω ) \cdot {L}_{12} \\ {f}_{2} ( ω ) \cdot {L}_{21} & {f}_{2} ( ω ) \cdot {L}_{22}\end{matrix} ) \qquad ( EQUATION 13 )$$

Then we determine the adjacency matrix with the third degree of connections:

$${L}_{d} = ( \begin{matrix}{L}_{11} & … & {f}_{d} ( ω ) {L}_{1 d} \\ ⋮ & ⋱ & ⋮ \\ {f}_{d} ( ω ) {L}_{d 1} & … & {f}_{d} ( ω ) {L}_{dd}\end{matrix} ) = ( \begin{matrix}{L}_{d - 1} & & {f}_{d} ( ω ) {L}_{1 d} \\ & & ⋮ \\ {f}_{d} ( ω ) {L}_{d 1} & … & {f}_{d} ( ω ) {L}_{dd}\end{matrix} ) \qquad ( EQUATION 14 )$$

One implementation of f_{d}(ω) is:

f_{d}(ω)=ω^{d-1} (EQUATION 15)

Where ω controls the rate of influence attenuation in a power manner. Another implementation of f_{d}(ω) is:

f_{d}(ω)=e^{-ω(d-1)} (EQUATION 16)

Where ω controls the rate of influence attenuation in an exponential manner.

### Targeting Advertisements to Influential Users

According to example embodiments, the various determinations of user influence described above (e.g., authority and hub scores, or a single influence score) with regard to various topics may be used for marketing and advertisements. Currently, online advertisements are targeted based on user attributes like demographic data, websites visited, what type of computer/browser is being used, etc. It is an advantage of the present approach that advertisers and advertisement networks with access to user influence data (determined as described herein) may target their ads directly to users who, for example, express a strong interest in particular topics, are authoritative on various topics (e.g., influential advocates of the subject matter, having high influence scores in certain topics), and/or who are well connected to other users with regard to a particular topic.

The present example approaches allow advertisers/ad networks/publishers to target users with more relevant ads. Relevant ads are those that interest users. A publisher, advertising network, advertiser, or any party that involves in delivering advertisements may target a user, or a plurality of users, differently according to the derived interests of the said user, or the said plurality of users. By targeting the user differently, it means delivering different sets of ads (e.g., more cooking ads than car ads for users whose interest is cooking) or arranging ads differently (e.g., with different layouts, colors, etc.).

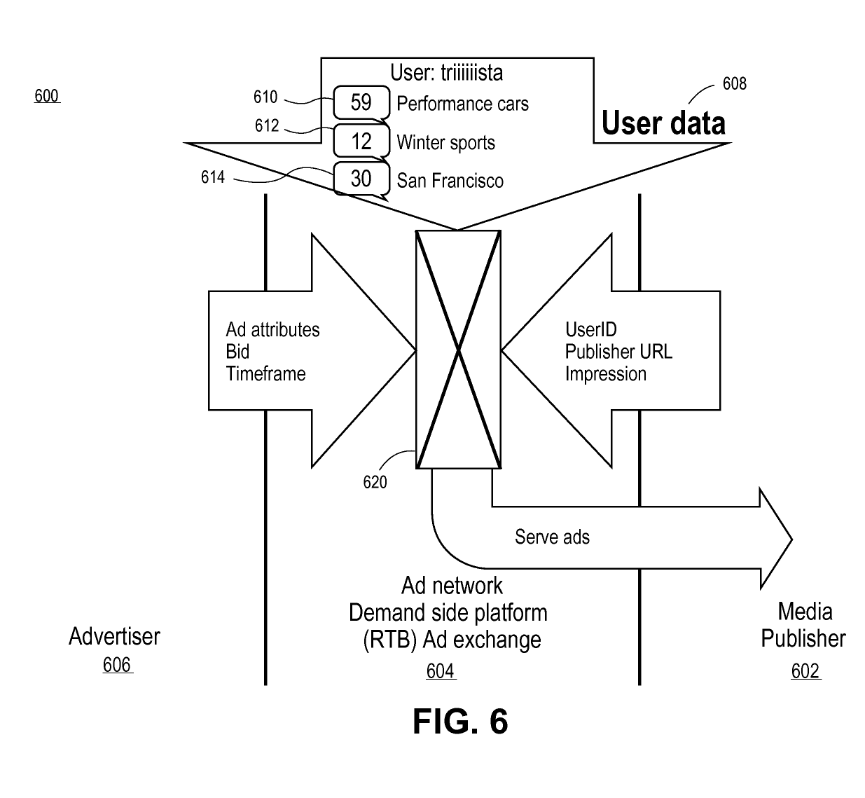

FIG. 6 is a diagram 600 of an example implementation of utilizing user influence in the context of online advertising. The example online advertising system of FIG. 6 includes three entities: content/media publishers 602, ad networks/exchanges/demand-side platforms 604, and advertisers 606. A sample user 608 (“triiiista”) is a website visitor with TOIs 610-614 in “performance cars,” “winter sports,” and “San Francisco.” User 608 logs into a content publisher website 602, perhaps with a Twitter login or a Facebook Connect login. Content publisher website 602 sends information to an ad network 604. This information may include the content publisher website 602 publisher information, impression information, and sample user's 608 user influence data (e.g., TOI information). In an embodiment, content publisher website 602 may have access to sample user's 608 user influence data because sample user's 608 user influence data has been stored on a server and made available to various parties.

Ad network 604 has information such as advertisers' 606 campaign information (e.g., bids and time frames), and may utilize that information along with content publisher website 602 publisher information, impression information, and sample user's 608 user influence data to determine the most appropriate advertisements to deliver. A ad determination module 620 may be used in an example of a technique for correlating all necessary information in order to determine the most appropriate advertisements to deliver to a particular user.

In an embodiment, ad network 604 has access to a user influence database, allowing it to deliver ads to impressions associated with users influential in the topics of choice. For example, it can deliver Toyota ads to impressions associated with user trnmsta, who is influential in “performance cars,” rather than another user that has no influence in such topic. The ads will be more effective. With user influence data in mind, Toyota may design their ad campaign to specifically target users that are influential in cars, in addition to relying on traditional demographic targeting.

### Alternate Implementations

To implement some or all of the various technologies described above, components described in the present specification or other systems not explicitly described herein may provide one or more application programming interfaces (APIs) or other interfacing logic or circuitry to allow the described components to communicate with the various systems described herein to facilitate those technologies.

While specific methods, tasks, operations, and data described herein are associated above with specific systems, other embodiments in which alternative apportionment of such tasks and data among the various systems are also possible. Further, while various systems, may be shown as separate entities in the Figures, one or more of these systems may be combined into one or more larger computing systems in other embodiments.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

Example embodiments may be implemented in digital electronic circuitry, or in computer hardware, firmware, or software, or in combinations thereof. Example embodiments may be implemented using a computer program product (e.g., a computer program tangibly embodied in an information carrier in a machine-readable medium) for execution by, or to control the operation of, data processing apparatus (e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communications network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a field programmable gate array (FPGA) or an application-specific integrated circuit (ASIC)).

The computing system can include clients and servers. While a client may comprise a server and vice versa, a client and server are generally remote from each other and typically interact through a communication network. The relationship of client and server arises by virtue of computer programs running on their respective computers and having a client-server relationship to each other. In embodiments deploying a programmable computing system, it will be appreciated that both hardware and software architectures may be considered. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set forth hardware (e.g., machine) and software architectures that may be deployed in various example embodiments.

Thus, methods and systems for generation and employment of wireless audio transmission have been described. Although the present subject matter has been described with reference to specific example embodiments, it will be evident that various modifications and changes may be made to these embodiments without departing from the broader scope of the subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” and so forth are used merely as labels and are not intended to impose numerical requirements on their objects.

The Abstract of the Disclosure is provided to comply with 37 C.F.R. §1.72(b), requiring an abstract that will allow the reader to quickly ascertain the nature of the technical disclosure. The Abstract is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### Hardware Mechanisms

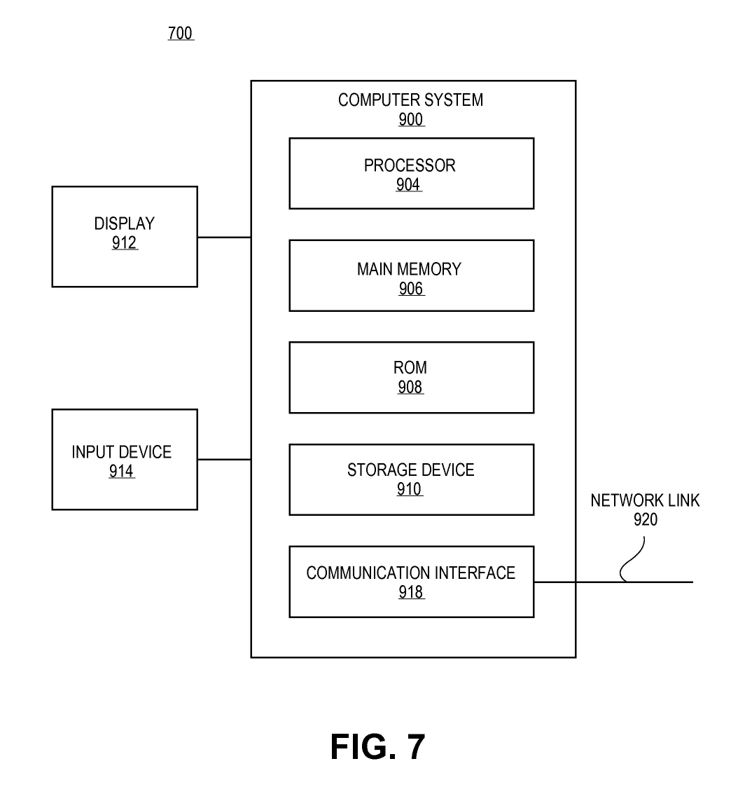

In an embodiment, embodiments of the invention may be implemented on, include, or correspond to a computer system. For example, the processes described herein may be performed, in certain embodiments, by one or more software modules executing on one or more computer systems. FIG. 7 is a block diagram that illustrates a computer system 900 upon which an embodiment of the invention may be implemented. In an embodiment, computer system 900 includes processor 904, main memory 906, ROM 908, storage device 910, and communication interface 918. Computer system 900 includes at least one processor 904 for processing information. Computer system 900 also includes a main memory 906, such as a random access memory (RAM) or other dynamic storage device, for storing information and instructions to be executed by processor 904. Main memory 906 also may be used for storing temporary variables or other intermediate information during execution of instructions to be executed by processor 904. Computer system 900 further includes a read only memory (ROM) 908 or other static storage device for storing static information and instructions for processor 904. A storage device 910, such as a magnetic disk or optical disk, is provided for storing information and instructions.

Computer system 900 may be coupled to a display 912, such as a cathode ray tube (CRT), a LCD monitor, and a television set, for displaying information to a user. An input device 914, including alphanumeric and other keys, is coupled to computer system 900 for communicating information and command selections to processor 904. Other non-limiting, illustrative examples of input device 914 include a mouse, a trackball, or cursor direction keys for communicating direction information and command selections to processor 904 and for controlling cursor movement on display 912. While only one input device 914 is depicted in FIG. 9, embodiments of the invention may include any number of input devices 914 coupled to computer system 900.

Embodiments of the invention are related to the use of computer system 900 for implementing the techniques described herein. According to one embodiment of the invention, those techniques are performed by computer system 900 in response to processor 904 executing one or more sequences of one or more instructions contained in main memory 906. Such instructions may be read into main memory 906 from another machine-readable medium, such as storage device 910. Execution of the sequences of instructions contained in main memory 906 causes processor 904 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “machine-readable storage medium” as used herein refers to any tangible medium that participates in storing instructions which may be provided to processor 904 for execution. Such a medium may take many forms, including but not limited to, non-volatile media and volatile media. Non-volatile media includes, for example, optical or magnetic disks, such as storage device 910. Volatile media includes dynamic memory, such as main memory 906.

Non-limiting, illustrative examples of machine-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of machine readable media may be involved in carrying one or more sequences of one or more instructions to processor 904 for execution. For example, the instructions may initially be carried on a magnetic disk of a remote computer. The remote computer can load the instructions into its dynamic memory and send the instructions over a network link 920 to computer system 900.

Communication interface 918 provides a two-way data communication coupling to a network link 920 that is connected to a local network. For example, communication interface 918 may be an integrated services digital network (ISDN) card or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through a local network to a host computer or to data equipment operated by an Internet Service Provider (ISP).

Computer system 900 can send messages and receive data, including program code, through the network(s), network link 920 and communication interface 918. For example, a server might transmit a requested code for an application program through the Internet, a local ISP, a local network, subsequently to communication interface 918. The received code may be executed by processor 904 as it is received, and/or stored in storage device 910, or other non-volatile storage for later execution.

In the foregoing specification, example embodiments have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-readable storage medium storing one or more sequences of instructions for analyzing digital content associated with an entity, which when executed by one or more processors, causes:
identifying a set of digital content that the entity has submitted to one or more social media services, wherein the set of digital content includes one or more digital pictures; and
identifying a set of actual interests for the entity based on the set of digital content, wherein identifying comprises:
analyzing each of the one or more digital pictures to identify a set of visual attributes for each digital photo,
determining, based on the set of visual attributes, one or more descriptive labels that characterize the content shown in each of the one or more digital photos based on the set of visual attributes for the digital photo,
assigning, for each of the one or more digital pictures, one or more subject categories based upon the one or more descriptive labels determined for each of the one or more digital pictures, and
identifying the set of actual interest based, at least in part, upon the one or more subject categories associated with the one or more digital pictures.

2. The computer-readable storage medium of claim 1, wherein the entity is a single user.

3. The computer-readable storage medium of claim 1, wherein the entity is a grouping of multiple users.

4. The computer-readable storage medium of claim 1, wherein at least one of the one or more digital pictures corresponds to a frame of digital video.

5. The computer-readable storage medium of claim 1, wherein identifying a set of actual interests for the entity further comprises:
identifying one or more labels that characterize the content shown in a video based on an analysis of how bounded regions of color move over time in the video.

6. The computer-readable storage medium of claim 1, wherein the set of actual interests identified for the entity is associated with a particular point in time, and wherein the set of actual interests identified for the entity is adjusted over time according to the expression:
updated TOI=(1−α)*(current TOI)+α*(incremental TOI),
wherein the term updated TOI corresponds to a newly calculated topic of interest value, wherein the term current TOI corresponds to a most recently calculated topic of interest value that considers a historical record of use for the entity, wherein the term incremental TOI corresponds to a newly obtained topic of interest value that does not consider data from an earlier period of time, and wherein a has a value ranging from 0 to 1.

7. The computer-readable storage medium of claim 6, wherein different topics of interest have a different value a.

8. The computer-readable storage medium of claim 1, wherein execution of the one or more sequences of instructions further causes:
identifying a set of probable interests for the entity based on the set of actual interests determined for the entity.

9. The computer-readable storage medium of claim 1, wherein execution of the one or more sequences of instructions further cause:
identifying, for a particular interest in the set of actual interests, an authority score and a hub score for the entity within the one or more social media services, wherein the authority score is a measure of how authoritative the entity is on the particular interest, and wherein the hub score is a measure of the breadth and usefulness of content linked to or provided by the entity within the one or more social media services on the particular interest.

10. The computer-readable storage medium of claim 9, wherein execution of the one or more sequences of instructions further causes:
generating a single influence score based on the authority score and the hub score, wherein the single influence score is a measure of how influential the entity is on the particular interest within the one or more social media services.

11. The computer-readable storage medium of claim 9, wherein execution of the one or more sequences of instructions further causes:
issuing directing marketing to the entity based on the authority score identified for the entity or hub score identified for the entity on the particular subject.

12. The computer-readable storage medium of claim 1, wherein execution of the one or more sequences of instructions further causes:
deriving the influence of the entity within the one or more social media services on a particular interest based, at least in part, upon the influence of the entity determined for one or more other interests.

13. A method for analyzing digital content associated with an entity, comprising:
identifying a set of digital content that the entity has submitted to one or more social media services, wherein the set of digital content includes one or more digital pictures; and
identifying a set of actual interests for the entity based on the set of digital content, wherein identifying comprises:
analyzing each of the one or more digital pictures to identify a set of visual attributes for each digital photo,
determining, based on the set of visual attributes, one or more descriptive labels that characterize the content shown in each of the one or more digital photos based on the set of visual attributes for the digital photo,
assigning, for each of the one or more digital pictures, one or more subject categories based upon the one or more descriptive labels determined for each of the one or more digital pictures, and
identifying the set of actual interest based, at least in part, upon the one or more subject categories associated with the one or more digital pictures.

14. The method of claim 13, wherein the entity is a single user or a grouping of multiple users.

15. The method of claim 13, wherein the set of actual interests identified for the entity is associated with a particular point in time, and wherein the set of actual interests identified for the entity is adjusted over time according to the expression:
updated TOI=(1−α)*(current TOI)+α*(incremental TOI),
wherein the term updated TOI corresponds to a newly calculated topic of interest value, wherein the term current TOI corresponds to a most recently calculated topic of interest value that considers a historical record of use for the entity, wherein the term incremental TOI corresponds to a newly obtained topic of interest value that does not consider data from an earlier period of time, and wherein α has a value ranging from 0 to 1.

16. The method of claim 13, wherein different topics of interest have a different value α.

17. An apparatus for analyzing digital content associated with an entity, comprising:
one or more processors; and
one or more computer-readable mediums storing one or more sequences of instructions, which when executed, cause:
identifying a set of digital content that the entity has submitted to one or more social media services, wherein the set of digital content includes one or more digital pictures; and
identifying a set of actual interests for the entity based on the set of digital content, wherein identifying comprises:
analyzing each of the one or more digital pictures to identify a set of visual attributes for each digital photo,
determining, based on the set of visual attributes, one or more descriptive labels that characterize the content shown in each of the one or more digital photos based on the set of visual attributes for the digital photo,
assigning, for each of the one or more digital pictures, one or more subject categories based upon the one or more descriptive labels determined for each of the one or more digital pictures, and
identifying the set of actual interest based, at least in part, upon the one or more subject categories associated with the one or more digital pictures.

18. The apparatus of claim 17, wherein the entity is a single user or a grouping of multiple users.

19. The apparatus of claim 17, wherein the set of actual interests identified for the entity is associated with a particular point in time, and wherein the set of actual interests identified for the entity is adjusted over time according to the expression:
updated TOI=(1−α)*(current TOI)+α*(incremental TOI),
wherein the term updated TOI corresponds to a newly calculated topic of interest value, wherein the term current TOI corresponds to a most recently calculated topic of interest value that considers a historical record of use for the entity, wherein the term incremental TOI corresponds to a newly obtained topic of interest value that does not consider data from an earlier period of time, and wherein α has a value ranging from 0 to 1.

20. The apparatus of claim 17, wherein different topics of interest have a different value α.
